(19) United States
(12) Patent Application Publication
(10) Pub. No.: US 2009/0245062 A1
(43) Pub. Date: Oct. 1, 2009

(54) METHOD AND APPARATUS FOR EDITING AN OPTICAL DISC

(75) Inventors: Bei Wang, Shanghai (CN); Kelly Patrick Declan, Shanghai (CN)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/090,892

(22) PCT Filed: Oct. 18, 2006
(86) PCT No.: PCT/IB2006/053827

§ 371 Date: Apr. 21, 2008

(30) Foreign Application Priority Data
Oct. 24, 2005 (CN) 200510118029.0

(51) Int. Cl. G11B 27/00

(52) U.S. Cl. 369/83; G9B/27

(57) ABSTRACT

A method is provided for editing an optical disc having a plurality of application-functional-layers. The method comprises the steps of obtaining description information of an edit performed on a program data in one of the layers, and generating a sharing information according to the description information in order to correspondingly edit application files in the other layer (s) of the optical disc. With the method and apparatus, the edit performed on one layer of the optical disc may be identified in other functional layer (s) and be used to edit and update the corresponding application files in those layers, so as to avoid conflict between the program data and application file.

### FIELD OF THE INVENTION

The present invention relates to the field of optical storage, in particular to a method and an apparatus for editing an optical disc.

### BACKGROUND OF THE INVENTION

In the technical field of optical storage, the same optical disc format may offer different layers of writing, playing and editing functions to an optical disc so as to meet consumption requirements of different levels. Higher functional layer may provide various high-performanced navigation functions like an ample menu, interaction, while lower functional layer provides relatively simple and conventional navigation functions like a simplified menu. Different functional layers may process shared data like video or audio programs.

Generally, apparatus for playing an optical disc with high function may compatibly play an optical disc with low function, while apparatus for playing an optical disc with low function may only play the low functional parts of the optical disc with high function, but it may not identify and use the high functional parts thereof.

Apparatus for writing an optical disc with high function may edit and modify application files both in high functional layer and low functional layer, so that if a program is edited, it may be kept consistent with the application files in each functional layer. An apparatus for writing an optical disc with low function may also edit a re-writable disc with high function, whereas such editing is only limited to the identifiable low functional parts. For example, an apparatus for writing an optical disc with low function may delete a segment of video content data, and the application supporting the low function may also be updated correspondingly, so as to ensure the consistency between the video contents and the application. However, the apparatus cannot modify at the same time an application corresponding to the deleted content that supports high function.

If said optical disc with high function, which has been edited by apparatus for writing an optical disc with low function, is played back in an apparatus for playing an optical disc with high function, the corresponding applications supporting high function will still invoke the segment of video data that has been deleted, since these applications are not modified and edited correspondingly, and consequently error will inevitably be incurred.

Therefore, there is a need for providing a method and an apparatus for editing an optical disc so as to ensure smoothly playing back and avoid errors when the re-writable optical disc has been edited at one functional layer while not at other functional layer(s).

### OBJECT AND SUMMARY OF THE INVENTION

The object of the present invention is to provide a method and an apparatus for editing an optical disc so as to overcome the defect of the prior art.

According to one embodiment of the present invention, a method for editing an optical disc is provided for editing an optical disc having a plurality of application-functional-layers, said method includes the steps of obtaining a description information of an edit performed on a program data in one of the layers; and generating a sharing information according to the description information in order to correspondingly edit application files in the other layers of the optical disc.

The method may further include the step of editing the program data at the functional layer. Said method may also include the step of editing the sharing information in the sharing information file, wherein said sharing information file could be either newly created or existing in the file system.

If the edit of the program data is performed at lower functional layer, the sharing information may be comparing information between an original description information and the edited (deleted or partially deleted) description information of the program data, and the comparing information may be applied to higher functional layer to update and edit the corresponding application file. If the edit of the program data is performed at higher functional layer, the sharing information may be explanations or limitations of the manners in which the higher functional layer could edit the lower functional layer.

According to one embodiment of the present invention, an apparatus for editing an optical disc is provided for editing an optical disc having a plurality of functional layers, said apparatus comprises means for obtaining a description information of an edit performed on a program data in one of the layers; and means for generating a sharing information according to the description information in order to correspondingly edit application files in the other layers of the optical disc.

The apparatus may also comprise means for editing the program data at the functional layer. The apparatus may also comprise means for editing said sharing information in one sharing information file, wherein said sharing information file could be either newly created or existing in the file system. The sharing information file may be timely updated. For example, said sharing information may be deleted after the application files at all the relevant functional layers have been correspondingly updated according to said sharing information.

The plurality of functional layers mentioned in the present invention includes two or more functional layers. The method and apparatus for editing an optical disc provided by the present invention are applicable to the re-writable optical disc, on which different application-functional-layers are provided.

By means of the method and apparatus for editing an optical disc provided by the present invention, the optical disc editing (e.g., adding, deleting, etc.) performed on a program data at one functional layer may be confirmed by other functional layer(s), and may be used for editing and updating corresponding application files, so as to avoid conflict between the program data and applications.

Other objects and attainments together with a further understanding of the invention will become apparent and appreciated by referring to the following description and claims, taken in conjunction with the accompanying drawings.

### BRIEF DESCRIPTION OF THE DRAWINGS

The present invention is further explained in detail by means of the embodiments with reference to the drawings.

FIG. 1 is the flowchart of the method for editing an optical disc according to one embodiment of the present invention.

FIG. 2 is the block diagram of the apparatus for editing an optical disc according to one embodiment of the present invention.

FIG. 3 is the schematic drawing of the apparatus for writing an optical disc of low function when editing a program data according to one embodiment of the present invention.

FIG. 4-1 is the schematic drawing of the time information corresponding to the playlist of an initial Blu-ray optical disc.

FIG. 4-2 is the schematic drawing of the time information of a playlist corresponding to the playlist in FIG. 4-1 after the program data is edited.

In all of said figures, the same signs represent the same, like or corresponding features or functions.

### DETAILED DESCRIPTION OF THE INVENTION

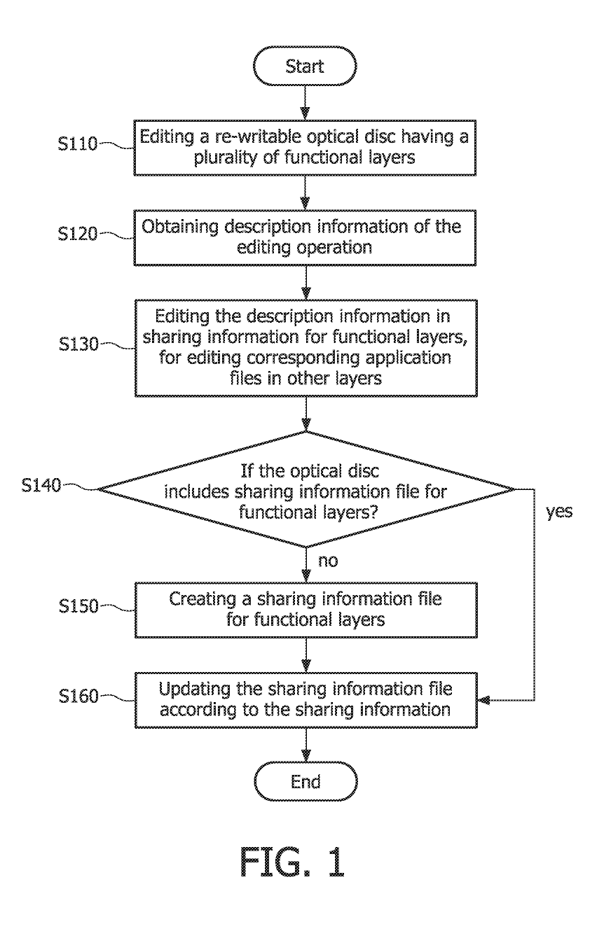

FIG. 1 is the flowchart of the method for editing an optical disc according to one embodiment of the present invention. Firstly, the apparatus for writing an optical disc edits a program data on a re-writable optical disc having a plurality of functional layers (step S110), for example, deleting said program, or deleting part of said program, or inserting a segment of commercial advertisement data, or writing a new program on the optical disc, etc.

Besides editing on program data, the editing operation may update the corresponding application file at the functional layer, no matter which functional layer the apparatus supports. For example, if an apparatus for writing an optical disc is a writing apparatus supporting basic functional layer, i.e., the apparatus only supports writing an optical disc with basic functional layer, the above-mentioned editing operation on program data is accompanied by modification of the applications and navigation files at the same functional layer. Such modification will not be implemented on applications or navigation files in other functional layer(s), even if they are relevant to the modified program contents.

Nevertheless, if an apparatus for writing an optical disc is a writing apparatus supporting high functional layer, that is, the apparatus not only supports low functional layer, but also high functional layer, the above-mentioned editing operation on program data is accompanied by modification of the applications and navigation files at all the corresponding functional layer.

Afterwards, description information about the editing operation is obtained (step S120). The description information includes titles of the concerned program data object, types of the editing (deleting, adding, replacing, etc.), the information of the involved segment of the program data information (start time, start address, etc.), the time performing said editing operation, and the functional layer where said operation is performed, etc.

Subsequently, said description information is edited into a layers-sharing information (step S130) for being used in other functional layer(s) to update the applications, navigation files, and so on, which are relevant to the edited program data. The sharing information may be identified by different functional layers. The sharing information may include two types. One is generated in high functional layer for transferring information to low functional layer, and the other is generated in low functional layer for transferring information to high functional layer.

When writing an optical disc with high function (e.g., storing a new program data), the editing operation performed at the low functional layer may be limited by means of the sharing information in order to avoid those operations affect the operations of high functional layer. For example, an application at the high functional layer relevant to a program should be deleted with the deletion of the program, or it should be reserved instead of being deleted, or a certain part therein should be deleted, etc.

When writing an optical disc with low function, the apparatus may transfer by means of the sharing information the changes (e.g., being deleted, etc.) caused to the program data by the editing operation to an apparatus for playing/writing an optical disc with high function, so that the apparatus for playing an optical disc with high function may avoid invoking error during the playing, and the apparatus for writing an optical disc with high function may update and modify corresponding applications and other related navigation files.

Then, it is judged whether there is a sharing information files for all functional layers on the optical disc (step S140). The sharing information generated according to step S130 may be edited in such a sharing information file.

If there is no sharing information file on the optical disc, a sharing information file may be created (step S150), and the sharing information generated in step S130 may be added into the file. As an information-transferring file for all functional layers, said file may be identified and used by each functional layer. If the optical disc stores such a sharing information file, the sharing information generated in step S130 is added to said sharing information file (S160).

If all the applications or navigation files in other relevant functional layers have been updated according to the sharing information (e.g., the apparatus for writing an optical disc with high function deletes one application file only relevant to the deleted program contents according to the sharing information), it is not necessary to keep the sharing information, thus the sharing information may be deleted, so as to timely update the sharing information file.

With the method for editing an optical disc provided by the present invention, an editing (e.g., adding, deleting, etc.) performed at one functional layer may be identified by other functional layer(s), and corresponding editing may be performed in other layers according to sharing information. Therefore operation error may be avoided, which is usually generated because of the change of the object.

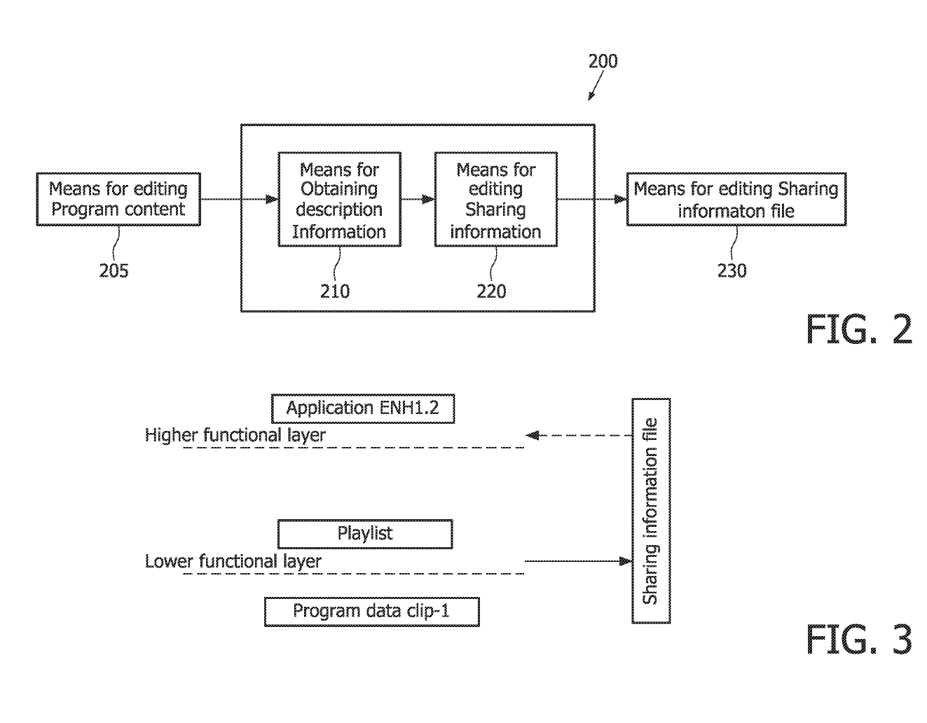

FIG. 2 is the block diagram of the apparatus 200 for editing an optical disc according to one embodiment of the present invention. The apparatus 200 comprises an obtaining means 210 for obtaining information about the editing of a program data. The editing operation performed on a program data on the optical disc involves the corresponding description information. For example, the names of the data objects to which the editing operation is directed, the types (adding, deleting, replacing, etc.) of the editing operation, data segment information (start time and end time, start address and end address, etc.) of the program content involved, the time of performing of the editing operation, and the functional layer of performing said operation, etc.

The apparatus 200 further comprises a-sharing-information editing means 220 for generating sharing information for functional layers according to the description information, so as to edit the application files relevant to said program data at other functional layer(s). The description information about the editing operation is used for the other functional layer(s) to identify the specific details of said editing operation, and thereby to determine the editing to be performed on the applications and navigation files relevant thereto.

The apparatus 200 may further comprise a-sharing-information-file editing means 230 for generating a sharing information file and editing the sharing information generated by means 220 into the file. The apparatus 200 may further comprise a program-data editing means for editing program data on the optical disc.

The apparatus for editing an optical disc provided by the present invention may be arranged in an apparatus for writing an optical disc, and the sharing information may be written onto a disc through the optical reading/writing component of the latter apparatus, and the sharing information file may be also updated. Therefore the apparatus for writing an optical disc is provided in the present invention.

When editing a program data clip-1 in high function layer, in order to avoid conflict between the program data and the application in low functional layer, sharing information may be generated to transfer the editing operations to low functional layer, in which the specific operation of the low function layer may be defined. When the low functional layer edits the program data, it will proceed according to the operation limitations in the sharing information, for example, deleting the files of some high functional layer, etc.

Table 1 below is a schematic table of a sharing information ENH_FILES. EXT generated during editing a program data at the high functional layer of an optical disc. With respect to program data clip-1, the information transferred from the high functional layer (i.e. enhanced layer) to the low functional layer (i.e. base layer) by sharing information is that if clip-1 is to be deleted at the low functional layer, the deleting operation must also delete the two application files ENH1.1 and ENH1.2 which is in the high functional layer. It is not necessary to identify their contents. If operation in the low functional layer is only limited to general editing (such as modifying some contents thereof), ENH1.1 should also be deleted, while ENH1.2 should be retained since the sharing information does not concern ENH1.2.

TABLE 1
sharing information transferred from high
functional layer to low functional layer

ENH_FILES. TXT
Base-clip-1-delete
ENH1.1-delete
ENH1.2-delete
Base-clip-1-edit
ENH1.1-delete

Another format of sharing information ENH_FILES. TXT generated during the editing of a program data at the high functional layer according to one embodiment of the present invention is shown in table 2. With respect to program data clip-1, the information transferred from the high functional layer to the low functional layer by the sharing information is that when clip-1 is edited in the low functional layer, operations on the application files ENH1.1 and ENH1.2 in the high functional layer should be also performed correspondingly (delete or keep).

TABLE 2
another format of sharing information transferred
from high functional layer to low functional layer

ENH_FILES.TXT
Base-clip-1-delete
ENH1.1-delete
ENH1.2-keep

Therefore, the optical disc playing/writing apparatus with low function may correspondingly edit ENH1.1 and ENH1.2 by means of identifying the sharing information (ENH_FILES. TXT) so as to ensure consistency between program data and application file.

While an apparatus for writing an optical disc with low function edits a program data (such as clip-1), it shall also correspondingly modify the relevant application file at the low functional layer. In order to avoid conflict between the edited clip-1 and the application file at the high functional layer, the writing apparatus with low function needs to transfer to the high functional layer those information about the editing performed on the program data by the sharing information. Therefore a writing apparatus with high function may update application files at the high functional layer according to the sharing information, or the playing apparatus with high function may refuse to play program contents on which editing operations like deleting have been performed.

FIG. 3 is the schematic drawing of an apparatus for writing an optical disc with low function editing a program data according to one embodiment of the present invention. As shown in FIG. 3, the low functional layer of the optical disc includes a playlist file, which supports the low-level playing function of program data clip-1, such as playing in sequence, etc. The high functional layer includes an enhanced application file (ENH1.2), which could control clip-1 to realize higher function such as interactive playing function, etc.

When the apparatus for writing an optical disc with low function edits clip-1, it generates sharing information according to the description information of the edit performed on clip-1. The sharing information may include the differential information between the original playlist file and the edited playlist file, and so on. An apparatus for writing an optical disc with high function will update the application file ENH-1.2 at the high functional layer, thereby to achieve consistent playing and avoid playing error.

The Blu-Ray disc (BD) format will be taken herein as an example. The Playlist-1 of the optical disc includes several play items corresponding to different program data. A playlist file in Blu-Ray disc format is as follows:

Playlist-1

| Syntax | No. of bits |
|---|---|
| PlayList( ) { | |

| | |
|---|---|
| Length | 32 |
| Number_of_PlayItems | 16 |
| For(PlayItem_id=0; | |

PlayItem_id<number_of_PlayItems;
PlayItem_id++) {

PlayItem( )
}

}

Wherein the structures of the play items mentioned above are as follows:

| Syntax | No. of bits |
|---|---|
| PlayItem( ) { | |

| | |
|---|---|
| Length | 16 |
| Clip_file_name | 8*5 |
| IN_time | 32 |
| OUT_time | 32 |

}

The program data on the optical disc may be played under the playing mode of low function according to the function provided in the playlist.

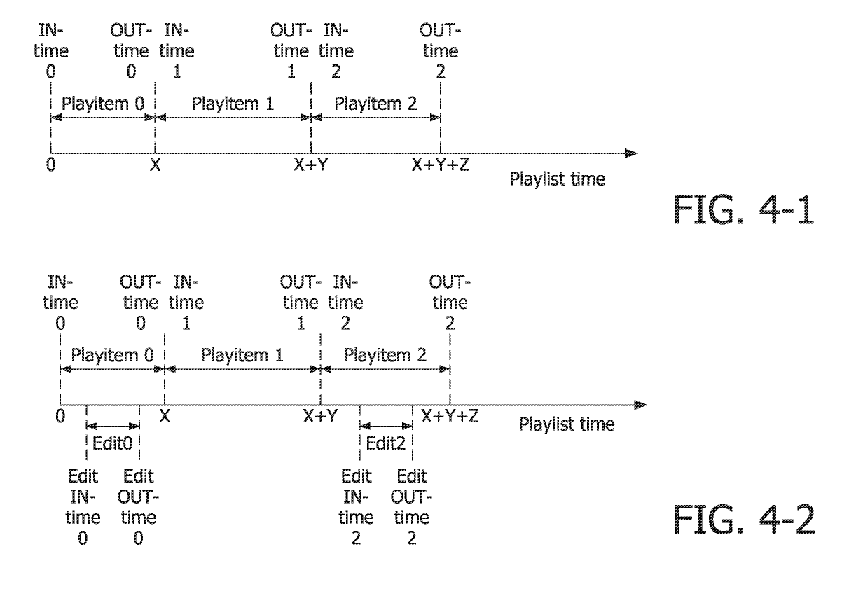

FIG. 4-1 is the schematic drawing of the timing of the playlist of an initial Blu-Ray optical disc. FIG. 4-1 corresponds to Playlist-1, and includes three play items, i.e., 0, 1 and 2. Each play item comprises the corresponding IN-time and OUT-time.

After performing edit 0 and edit 2 on the program data of playitems 0 and 2 at the low functional layer, FIG. 4-1 is changed into FIG. 4-2. FIG. 4-2 is the schematic drawing of the timing of Playlist-1 after the play items in playlist-1 have been edited.

The apparatus for writing an optical disc with low function cannot modify the application files of high function, but it can only generate sharing information according to the editing information as shown in FIG. 4-2. The sharing information may include playlists before and after editing, and it can also include the differential information between the playlists before and after editing, or it can also include the differential information concerning each playitem.

The following sharing information includes the edited playlist.

| Syntax | No. of bits |
|---|---|
| Differential_PlayList ( ) { | |

| | |
|---|---|
| Length | 32 |
| Number_of_PlayItems | 16 |
| For(PlayItem_id=0; | |

PlayItem_id<number_of_PlayItems;
PlayItem_id++) {

| | |
|---|---|
| PlayItem_Edit_Flag | 1 |
| reserved_for_word_align | 15 |
| If (PlayItem_edit_Flag == 1) { | |

Differential_PlayItem( )

}

}

Wherein PlayItem_Edit_Flag is the flag for determining whether a playitem has been edited, whose structure may be defined as follows:

| PlayItem_Edit_Flag | Meaning |
|---|---|
| 1 | PlayItem has been edited by base Layer |
| | recorder. |
| 0 | PlayItem has not been changed by base |
| | Layer recorder. |

If PlayItem_Edit_Flag=1, the play item has been edited in low functional layer, otherwise, it has not been edited yet.

As for the edited playitem, the playlist file further includes the differential information (Diferential_PlayItem) between the description information before and after the playitem has been edited. The differential information may be defined in the following way:

| Syntax | No. of bits |
|---|---|
| DifferentialPlayItem( ) { | |

| | |
|---|---|
| Length | 16 |
| Clip_file_name | 8*5 |
| Original_IN_time | 32 |
| Original_OUT_time | 32 |
| Number_of_edits | 16 |
| For(Edit_id = 0; | |

Edit_id<Number_of_edits;
Edit_id++) {

| | |
|---|---|
| Edit_IN_time | 32 |
| Edit_OUT_time | 32 |

}

}

Wherein, clip_file_name is the file name of the program data, Original_IN_time is the original IN-time of the program data, Original_OUT_time is the original OUT-time of the program data, Number_of_edits is the number of edits experienced by the program data, Edit_IN_time is the IN-time of the edit, and Edit_OUT_time is the OUT-time of the edit.

When playing an optical disc later on, an apparatus for playing an optical disc with high function may avoid playing a deleted program data according to the sharing information, while an apparatus for writing an optical disc with high function may update and edit the application file at the corresponding functional layers according to the sharing information, thus to avoid conflict between program data and application file.

While the invention has been described in conjunction with specific embodiments, it should be appreciated that many alternatives, modifications and variations will be apparent to those skilled in the art in light of the foregoing description. Accordingly, it is intended that all such alternatives, modifications and variations should fall within the spirit and scope of the appended claims.

1. A method for editing an optical disc with a plurality of application-functional-layers, comprises the steps of
obtaining a description information of an edit performed on a program data in one of the layers; and
generating a sharing information according to the description information in order to correspondingly edit application files in the other layer(s) of the optical disc.

2. The method according to claim 1, further comprising the step of editing the program data at the functional layer.

3. The method according to claim 1, further comprising the step of judging whether the optical disc comprises a sharing information file for the functional layers.

4. The method according to claim 3, further comprising the step of editing the sharing information in the sharing information file, if the optical disc comprises such a sharing information file.

5. The method according to claim 3, further comprising the steps of creating a sharing information file if the optical disc does not comprise such a sharing information file, and editing the sharing information in the sharing information file.

6. The method according to claim 1, wherein the description information comprises at least one of the following:
the name of the program, the address of the program data, the type of the editing, the time of performing of the editing, and the functional layer in which the edit is performed.

7. The method according to claim 1, wherein the sharing information comprises reference information for editing application files corresponding to the program data in the other functional layer(s).

8. The method according to claim 1, wherein the sharing information comprises the type information for editing application files corresponding to the program data in the other functional layer(s).

9. The method according to claim 1, wherein the sharing information comprises a differential information between the description information of the program data before and after the edit.

10. An apparatus for editing an optical disc with a plurality of functional layers, comprising:
means for obtaining a description information of an edit performed on a program data in one of the layers; and
means for generating a sharing information according to the description information in order to correspondingly edit application files in the other layers of the optical disc.

11. The apparatus according to claim 10, further comprising means for editing the program data at the functional layer.

12. The apparatus according to claim 10, further comprising
means for creating a sharing information file if the optical disc does not comprise such a sharing information file, and
means for editing the sharing information in the sharing information file.

13. The apparatus according to claim 10, wherein the description information comprises at least one of the following:
the name of the program, the address of the program data, the type of the editing, the time of performing of the editing, and the functional layer in which the edit is performed.

14. The apparatus according to claim 10, wherein the sharing information comprises reference information for editing application files corresponding to the program data in the other functional layer(s).

15. The apparatus according to claim 10, wherein the sharing information comprises the type information for editing application files corresponding to the program data in the other functional layer(s).

16. The apparatus according to claim 10, wherein the sharing information comprises differential information between the description information of the program data before and after the edit.

17. A device for writing an optical disc with a plurality of functional layers, the apparatus comprising:
an apparatus for writing data on the optical disc; and
an apparatus for editing the optical disc, comprising:
means for obtaining a description information of an edit performed on a program data in one of the layers, and
means for generating a sharing information according to the description information in order to correspondingly edit application files in the other layers of the optical disc;
wherein the sharing information is written on the optical disc through the apparatus for writing data.

18. The device according to claim 17, wherein the description information comprises at least one of the following:
the name of the program, the address of the program data, the type of the editing, the time of performing of the editing, and the functional layer in which the edit is performed.

19. The device according to claim 17, wherein the sharing information comprises reference information for editing application files corresponding to the program data in the other functional layer(s).

20. The device according to claim 17, wherein the sharing information comprises the type information for editing application files corresponding to the program data in the other functional layer(s).

21. The device according to claim 17, wherein the sharing information comprises differential information between the description information of the program data before and after the edit.
